(19) United States
(12) Patent Application Publication
(10) Pub. No.: US 2007/0135586 A1
(43) Pub. Date: Jun. 14, 2007

(54) Polyamide blend compositions formed article and process thereof

(76) Inventors: Shreyas Chakravarti, Evansville, IN (US); Ganesh Kannan, Evansville, IN (US); Peter H. Th. Vollenberg, Evansville, IN (US); Keshav S. Gautam, Evansville, IN (US)

Correspondence Address: GEAM - O8CV - CPP;IP LEGAL, ONE PLASTICS AVENUE, PITTSFIELD, MA, 01201-3697, US

(21) Appl. No.: 11/299,267

(22) Filed: Dec. 9, 2005

(51) Int. Cl. C08G 69/48

(52) U.S. Cl. 525/419

(57) ABSTRACT

A composition comprising a polymer blend of a polyamide resin and an immiscible cycloaliphatic polyester resin portion which may include a polycarbonate resin and a compatibilizer to enhance transparency, chemical resistance and mechanical properties.

### FIELD OF THE INVENTION

The invention relates to polyamide polymer blends, especially blends having a desired clarity and other favorable properties.

### BACKGROUND OF THE INVENTION

Polyamides especially amorphous polyamides (a-PA), are interesting engineering thermoplastics with excellent mechanical, barrier and chemical properties with the added advantage of transparency. This combination makes these materials unique to many applications in the industries that require performance along with good chemical resistance and optical clarity. The superior barrier properties of these materials translate also to their wide application in the packaging industry. Further, amorphous polyamides have been well known for their excellent chemical resistance to a wide range of commonly used chemicals. However, the polyamide has relatively low chemical resistance to hydrophilic chemicals. The incompatibility of polyamides with other polymers makes it difficult to design useful blends especially under constraints of maintaining the clarity in these systems. There is a need for transparent blends of thermoplastic resins with polyamides having enhanced chemical resistance particularly for containers of cosmetics.

US Patent Application Publication 2002/0173591 A1 to Chisholm et al describes a thermoplastic resin composition comprising a polyamide resin, a cycloaliphatic polyester resin, and a compatibilizing amount of a polyester ionomer for enhancing the properties of the blend.

US Patent publication U.S. Pat. No. 5,300,572A to Tojima et al discloses compositions comprising a polyester, polyester ionomer and polyolefin.

US Patent Application Publication 2003/0124358 A1 to Vollenberg et describes an article having an upper layer of an aliphatic polyamide resin and an intermediate layer which may include a polymeric ionomer.

U.S. Pat. No. 4,877, 848 relates to thermoplastic blends containing polyamide and epoxy functional compound wherein the blends include a resin selected from the group consisting of polycarbonate, poly(ester-carbonate), and polyarylate.

### SUMMARY OF THE INVENTION

According to an embodiment, there is provided a composition comprising a polymer blend of a polyamide resin and cycloaliphatic polyester

According to an embodiment, the polyamide resin comprises amorphous polyamide resins. According to an embodiment, the polyamide resin is immiscible with the cycloaliphatic polyester resin. According to an embodiment, the composition preferable has favorable properties of clarity, weather and chemical resistance.

According to an embodiment, additional ingredients in the resin formulation may enhance processing, and thermal, and color stability of the resin formulation transparent.

According to an embodiment, such additional ingredients may include reactive compatibilizers such as polyomeric ionomers, multifunctional epoxies, or oxazoline compositions, colorants and mixtures of such added ingredients.

According to an embodiment, a composition comprises a polymer blend of a polyamide resin having a predetermined index of refraction and an immiscible resin wherein the immiscible resin comprises a cycloaliphatic polyester resin and a resin miscible with said cycloaliphatic for adjusting the index of refraction of the immiscible resin to substantially match the index of refraction of said polyamide resin.

According to an embodiment, a substantially transparent article and process for producing a substantially transparent article are provided.

### BRIEF DESCRIPTION OF THE DRAWINGS

FIG. 1 is a graph showing the % transmission on the y-axis with the x-axis showing the Nylon/PC/PCCD blend as a function of % composition of PC in the blend.

### DETAILED DESCRIPTION OF THE INVENTION

An immiscible polymer blend includes one or more polyamide resins and a cycloaliphatic polyester resin. Polyamide resins include a generic family of resins known as nylons, characterized by the presence of an amide group (—C(O) NH—) and may be aliphatic, aromatic or a combination of aliphatic and aromatic. Preferred properties include optical transparency. Useful polyamide resins include all known polyamides and include polyamide, polyamide-6,6, polyamide-11, polyamide-12, polyamide-4,6, polyamide-6,10 and polyamide-6,12, as well as polyamides prepared from terephthalic acid and/or isophthalic acid and trimethylhexamethylenediamine; from adipic acid and m-xylenediamines; from adipic acid, azelaic acid, 2,2-bis-(p-aminocyclohexyl)propane, and from terephthalic acid and 4,4′-diaminodicyclohexylmethane. Mixtures and/or copolymers of two or more of the foregoing polyamides or prepolymers thereof, respectively, are also within the scope of the present invention. Useful examples of the polyamides or nylons, as these are often called, include for example: polypyrrolidone (nylon 4), polycaprolactam (nylon 6) polycaprolactam (nylon 8), polyhexamethylene adipamide (nylon 6,6), polyundecanolactam (nylon 11), polyundecanolactam (nylon 12), polyhexamethylene azelaiamide (nylon 6,9), polyhexamethylene, sebacamide (nylon 6,10), polyhexamethylene isophthalimide (nylon 6,1), polyhexamethylene terephthalamide (nylon 6,T), olyamide of hexamethylene diamine and n-dodecanedioic acid (nylon 6,12) as well as polyamides resulting from terephthalic acid and/or isophthalic acid and trimethyl hexamethylene diamine, polyamides resulting from adipic acid and meta xylenediamines, polyamides resulting from adipic acid, azelaic acid and 2, 2-bis-(p-aminocyclohexyl)propane and polyamides resulting from terephthalic acid and 4,4′-diamino-dicyclohexylmethane.

One polyamide resin is an aliphatic polyamide resins and includes include linear, branched and cycloaliphatic polyamides. These polyamides include the family of resins known generically as nylons, which are characterized by the presence of an amide group, and are represented generally by Formula 2 and Formula 3: 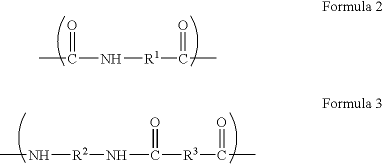
wherein R1-3 are each independently C1 to C20 alkyl, C1 to C20 cycloalkyl, and the like. For aromatic polyamides, at least one of R1-3 comprises an aromatic radical preferable a phenylene group. The preferred polyamides are characterized by their optical transparency.

Polyamides include Nylon-6 (Formula 2, wherein R1 is C4 alkyl) and nylon-6,6 (Formula 4, wherein R2 and R3 are each C4 alkyl). Other useful polyamides include nylon-4,6, nylon-12, nylon-6,10, nylon 6,9, nylon 6/6T and nylon 6,6/6T with triamine contents below about 0.5 weight %, and PACM 12. Still others include amorphous nylons.

The polyamides may be made by any known method, including the polymerization of a monoamnino monocarboxylic acid or a lactam thereof having at least 2 carbon atoms between the amino and carboxylic acid group, of substantially equimolar proportions of a diamine which contains at least 2 carbon atoms between the amino groups and a dicarboxylic acid, or of a monoaminocarboxylic acid or a lactam thereof as defined above, together with substantially equimolar proportions of a diamine and a dicarboxylic acid. The dicarboxylic acid may be used in the form of a functional derivative thereof, for example, a salt, an ester or acid chloride.

Polyarnides can be obtained by a number of processes, such as those described in U.S. Pat. Nos. 2,071,250; 2,071,251; 2,130,523; 2,130,948; 2,241,322; 2,312,966; and 2,512,606. Specifically, Nylon-6 is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane di-acid, and the like. Useful diarnines include, for example, di-(4-aminocyclohexyl)methane; 2,2-di-(4-aminocyclohexyl)propane, among others. A preferred polyamide is PACM 12, wherein R2 is di-(4-aminocyclohexyl)methane and R3 is dodecane diacid, as described in U.S. Pat. No. 5,360,891. Copolymers of caprolactam with diacids and diamines are also useful.

Suitable aliphatic polyamides have a viscosity of at least about 90, preferably at least about 110 milliliters per gram (ml/g); and also have a viscosity less than about 400, preferably less than about 350 ml/g as measured in a 0.5 wt % solution in 96 wt % sulphuric acid in accordance with ISO 307.

The polyamide used may also be one or more of those referred to as “toughened nylons”, which are often prepared by blending one or more polyamides with one or more polymeric or copolymeric elastomeric toughening agents. Examples of these types of materials are given in U.S. Pat. Nos. 4,174,358; 4,474,927; 4,346,194; 4,251,644; 3,884,882; 4,147,740; all incorporated herein by reference, as well as in a publication by Gallucci et al, “Preparation and Reactions of Epoxy-Modified Polyethylene”, J. APPL. POLY. SCI., V. 27, PP, 425-437 (1982). The preferred polyamides for this invention are polyamide-6; 6,6; 11 and 12, with the most preferred being polyamide-6,6. The polyamides used herein preferably have an intrinsic viscosity of from about 0.4 to about 2.0 dl/g as measured in a 60:40 m-cresol mixture or similar solvent at 23o-30o C.

It is within the skill of persons knowledgeable in the art to produce amorphous polyamides through any one of a combination of several methods. Faster polyamide melt cooling tends to result in an increasingly amorphous resin. Side chain substitutions on the polymer backbone, such as the use of a methyl group to disrupt regularity and hydrogen bonding, may be employed. Non-symmetric monomers, for instance, odd-chain diamines or diacids and meta aromatic substitution, may prevent crystallization. Symmetry may also be disrupted through copolymerization, that is, using more than one diamine, diacid or monoamino-monocarboxylic acid to disrupt regularity. In the case of copolymerization, monomers which normally may be polymerized to produce crystalline homopolymer polyamides, for instance, nylon-6, 6/6, 11, 6/3, 4/6, 6/4, 6/10, or 6/12, or 6,T may be copolymerized to produce a random amorphous copolymer. Need Amorphous polyamides for use herein are generally transparent with no distinct melting point, and the heat of fusion is about 1 cal/gram or less. The heat of fusion may be conveniently determined by use of a differential scanning calorimeter (DSC). One amorphous polyamide is poly(hexamethylene isophthalamide), commonly referred to as nylon-6,1.Nylon-6,1 is prepared by reacting hexamethylene diarnine with isophthalic acid or its reactive ester or acid chloride derivatives.

Blends of various polyamide resins as the polyamide component can comprise from about 1 to about 99 parts by weight preferred polyamides as set forth above and from about 99 to about 1 part by weight other polyamides based on 100 parts by weight of both components combined. Other polyamide resins, however, such as nylon-4,6, nylon-12, nylon-6,10, nylon 6,9, nylon 6/6T, nylon 6,6/6T, and nylon 9T with triamine contents below about 0.5 weight percent (wt %), as well as others, such as the amorphous nylons, may be useful in the poly(arylene ether)/polyamide composition. Mixtures of various polyamides, as well as various polyamide copolymers, may also be useful. The polyamide resin has a weight average molecular weight (Mw) greater than or equal to about 75,000, preferably greater than or equal to about 79,000, and more preferably greater than or equal to about 82, 000 as determined by gel permeation chromatography.

The cycloaliphatic polyesters are derived from cycloaliphatic diol and cycloaliphatic diacid compounds, a preferred cyloaliphatic polyester is polycyclohexane dimethanol cyclohexyl dicarboxylate (PCCD). The polyester having only one cyclic unit may also be useful. The aliphatic polyesters typically have a low glass transition temperature (Tg) which may improves the flow of a resulting blend. Another advantage is that the polyester improves may improve the overall chemical resistance towards various chemicals.

The cycloaliphatic polyester resin comprises a polyester having repeating units of the formula 4: 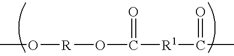
where at least one R or R1 is a cycloalkyl containing radical.

The polyester is a condensation product where R is the residue of an aryl, alkane or cycloalkane containing diol having 6 to 20 carbon atoms or chemical equivalent thereof, and R1 is the decarboxylated residue derived from an aryl, aliphatic or cycloalkane containing diacid of 6 to 20 carbon atoms or chemical equivalent thereof with the proviso that at least one R or R1 is cycloaliphatic. Preferred polyesters of the invention will have both R and R1 cycloaliphatic.

The present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mole % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

The polyester resins are typically obtained through the condensation or ester interchange polymerization of the diol or diol equivalent component with the diacid or diacid chemical equivalent component. R and R1 are preferably cycloalkyl radicals independently selected from the following formula 5:

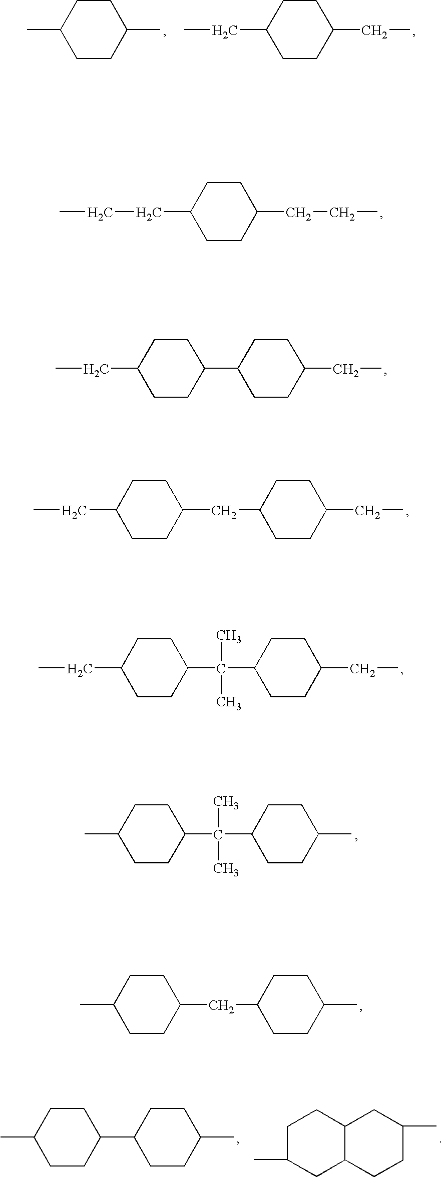

The preferred cycloaliphatic radical R1 is derived from the 1,4-cyclohexyl diacids and most preferably greater than 70 mole % thereof in the form of the trans isomer. The preferred cycloaliphatic radical R is derived from the 1,4-cyclohexyl primary diols such as 1,4-cyclohexyl dimethanol, most preferably more than 70 mole % thereof in the form of the trans isomer.

Other diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2-and 1,3-propylene glycol; 2,2-dimethyl-1,3-propane diol; 2-ethyl, 2-methyl, 1,3-propane diol; 1,3-and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; 2,2,4,4-tetramethyl-1,3-cyclobutanediol (TMCBD), triethylene glycol; 1,10-decane diol; and mixtures of any of the foregoing. Preferably a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like.

The diacids useful in the preparation of the aliphatic polyester resins of the present invention preferably are cycloaliphatic diacids. This is meant to include carboxylic acids having two carboxyl groups each of which is attached to a saturated carbon. Preferred diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid may also be useful.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. See, Friefelder et al., Journal of Organic Chemistry, 31, 3438 (1966); U.S. Pat. Nos. 2,675,390 and 4,754,064. They may also be prepared by the use of an inert liquid medium in which a phthalic acid is at least partially soluble under reaction conditions and with a catalyst of palladium or ruthenium on carbon or silica. See, U.S. Pat. Nos. 2,888,484 and 3,444,237.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well.

When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids, and the most favored chemical equivalent comprises the dimethyl ester of the acid, particularly dimethyl- 1,4-cyclohexane-dicarboxylate.

A preferred cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD) which has recurring units of formula 6:

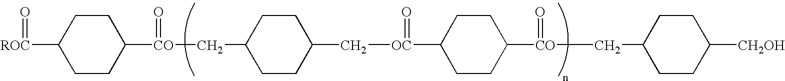

With reference to the previously set forth general formula, for PCCD, R is derived from 1,4 cyclohexane dimethanol; and R1 is a cyclohexane ring derived from cyclohexanedicarboxylate or a chemical equivalent thereof. The favored PCCD has a cis/trans formula.

The polyester polymerization reaction is generally run in the melt in the presence of a suitable catalyst such as a tetrakis(2-ethyl hexyl)titanate, in a suitable amount, typically about 50 to 200 ppm of titanium based upon the final product.

The preferred aliphatic polyesters used in the present transparent molding compositions have a glass transition temperature (Tg) which is above 50° C., more preferably above 80° C. and most preferably above about 100o C.

The cycolaliphatic polyester includes an index of refraction adjusting amount of a miscible polymer. The index adjusting miscible polymer is added in an amount so as to enhance the matching of the polyamide portion of the blend with the immiscible cycloaliphatic polyester portion. The polycarbonate polymer may be added to aid in adjusting the index of refraction of the immiscible cycloaliphatic polymer phase to match the index of refraction of the polyamide polymer phase. “Polycarbonate” and/or “polycarbonate composition” includes compositions having structural units of formula 7: 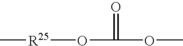
wherein R25 is aromatic organic radicals and/or aliphatic, alicyclic, or heteroaromatic radicals. Preferably, R25 is an aromatic organic radical and, more preferably, a radical having the formula -A1-Y1-A2- wherein each of A1 and A2 is a monocyclic divalent aryl radical and Y1 is a bridging radical having one or more atoms which separate A1 from A2. In an exemplary embodiment, one atom separates A1 from A2. Illustrative non-limiting examples of radicals of this type include: —0—, —S—, —S(O)—, —S(O2)-, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, adamantylidene, and the like. The bridging radical Y1 can be a hydrocarbon group or a saturated hydrocarbon group such as methylene, cyclohexylidene, or isopropylidene.

Suitable polycarbonates can be produced by the interfacial reaction of dihydroxy compounds in which only one atom separates A1 and A2. As used herein, the term “dihydroxy compound” includes, for example, bisphenol compounds having generally formula 8: 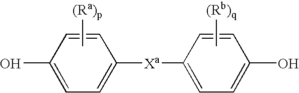
wherein Ra and Rb each represent a halogen atom or a monovalent hydrocarbon group and may be the same or different; p and q are each independently integers from 0 to 4; and Xa is one of the groups of formula 9: 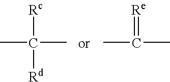
wherein Rc and Rd each independently represent a hydrogen atom or a monovalent linear or cyclic hydrocarbon group and Re is a divalent hydrocarbon group.

Some illustrative, non-limiting examples of suitable dihydroxy compounds include the dihydroxy-substituted aromatic hydrocarbons disclosed by name or formula (generic or specific) in U.S. Pat. No. 4,217,438. A nonexclusive list of specific examples of the types of bisphenol compounds represented by formula 11 includes: 1,1-bis(4-hydroxyphenyl)methane; 1,1-bis(4-hydroxyphenyl)ethane; 2,2-bis(4-hydroxyphenyl)propane (hereinafter “bisphenol A” or “BPA”); 2,2-bis(4-hydroxyphenyl)butane; 2,2-bis(4-hydroxyphenyl)octane; 1,1-bis(4-hydroxyphenyl)propane; 1,1-bis(4-hydroxyphenyl)n-butane; bis(4-hydroxyphenyl)phenylmethane; 2,2-bis(4-hydroxy-1-methylphenyl)propane; 1,1-bis(4-hydroxy-t-butylphenyl) propane; bis(hydroxyaryl)alkanes such as 2,2-bis(4-hydroxy-3-bromophenyl)propane; 1,1-bis(4-hydroxyphenyl)cyclopentane; and bis(hydroxyaryl)cycloalkanes such as 1,1-bis(4-hydroxyphenyl)cyclohexane.

Two or more different dihydric phenols or a copolymer of a dihydric phenol with a glycol or with a hydroxy (—OH) or acid-terminated polyester may be employed, or with a dibasic acid or hydroxy acid, in the event a carbonate copolymer rather than a homopolymer may be desired for use. Polyarylates and polyester-carbonate resins or their blends can also be employed. Branched polycarbonates are also useful, as well as blends of linear polycarbonate and a branched polycarbonate. The branched polycarbonates may be prepared by adding a branching agent during polymerization.

Suitable branching agents include polyfunctional organic compounds containing at least three functional groups, which may be hydroxyl, carboxyl, carboxylic anhydride, haloformyl, and mixtures thereof. Examples include, but are not limited to trimellitic acid, trimellitic anhydride, trimellitic trichloride, tris-p-hydroxy phenyl ethane, isatin-bis-phenol, 1,3,5-tris((p-hydroxyphenyl)isopropyl)benzene, 4(4(1,1 -bis(p-hydroxyphenyl)-ethyl, alpha,alpha-dimethyl benzyl)phenol, 4-chloroformyl phthalic anhydride, trimesic acid and benzophenone tetracarboxylic acid. Branching agents may be added at a level greater than about 0.05%. The branching agents may also be added at a level less than about 2.0% by weight of the total. Branching agents and procedures for making branched polycarbonates are described in U.S. Pat. No. 3,635,895 to Kramer, and U.S. Pat. No. 4,001,184 to Scott.

Preferred polycarbonates are based on bisphenol A, in which each of A1 and A2 of Formula 9 is p-phenylene and Y1 is isopropylidene. The average molecular weight of the polycarbonate is greater than about 5,000, preferably greater than about 10,000, most preferably greater than about 15,000. In addition, the average molecular weight is less than about 100,000, preferably less than about 65,000, most preferably less than about 45,000 g/mol.

Suitable polyesters include those derived from an aliphatic, cycloaliphatic, or aromatic diol, or mixtures thereof, containing from 2 to about 10 carbon atoms and at least one aromatic dicarboxylic acid. Preferred polyesters are derived from an aliphatic diol and an aromatic dicarboxylic acid having repeating units of the following general formula 10: 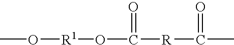
wherein R1 is an C6-C20 alkyl, or aryl radical, and R is a C6-C20 alkyl or aryl radical comprising a decarboxylated residue derived from an alkyl or aromatic dicarboxylic acid.

Examples of aromatic dicarboxylic acids represented by the decarboxylated residue R are isophthalic or terephthalic acid, 1,2-di(p-carboxyphenyl)ethane, 4,4′-dicarboxydiphenyl ether, 4,4′ bisbenzoic acid, and mixtures thereof. These acids contain at least one aromatic nucleus. Acids containing fused rings can also be present, such as in 1,4- 1,5- or 2,6-naphthalene dicarboxylic acids. The preferred dicarboxylic acids are terephthalic acid, isophthalic acid, naphthalene dicarboxylic acid or a mixture thereof.

The diol may be a glycol, such as ethylene glycol, propylene glycol, trimethylene glycol, 2-methyl-1,3-propane glycol, hexamethylene glycol, decamethylene glycol, cyclohexane dimethanol, or neopentylene glycol; or a diol such as 1,4-butanediol, hydroquinone, or resorcinol.

Also contemplated herein are the above polyesters with minor amounts, e.g., from about 0.5 to about 30 percent by weight, of units derived from aliphatic acids and/or aliphatic polyols to form copolyesters. The aliphatic polyols include glycols, such as poly(ethylene glycol). Such polyesters can be made following the teachings of, for example, U.S. Pat. Nos. 2,465,319 and 3,047,539.

The most preferred polyesters are poly(ethylene terephthalate) (“PET”), poly(1,4-butylene terephthalate), (“PBT”), and poly(propylene terephthalate) (“PPT”). One preferred a preferred PBT resin is one obtained by polymerizing a glycol component at least 70 mole %, preferably at least 80 mole %, of which consists of tetramethylene glycol and an acid component at least 70 mole %, preferably at least 80 mole %, of which consists of terephthalic acid, and polyester-forming derivatives therefore. The preferred glycol component can contain not more than 30 mole %, preferably not more than 20 mole %, of another glycol, such as ethylene glycol, trimethylene glycol, 2-methyl-1,3-propane glycol, hexamethylene glycol, decamethylene glycol, cyclohexane dimethanol, or neopentylene glycol. The preferred acid component can contain not more than 30 mole %, preferably not more than 20 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethane dicarboxylic acid, p-hydroxy benzoic acid, sebacic acid, adipic acid and polyester-forming derivatives thereof.

Block copolyester resin components are also useful, and can be prepared by the transesterification of (a) straight or branched chain poly(1,4-butylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. For example a poly(1,4-butylene terephthalate) can be mixed with a polyester of adipic acid with ethylene glycol, and the mixture heated at 235° C. to melt the ingredients, then heated further under a vacuum until the formation of the block copolyester is complete. As the second component, there can be substituted poly(neopentyl adipate), poly(1,6-hexylene azelate-coisophthalate), poly(1,6-hexylene adipate-co-isophthalate) and the like. An exemplary block copolyester of this type is available commercially from General Electric Company, Pittsfield, Mass., under the trade designation VALOX 330.

Especially useful when high melt strength is important are branched high melt viscosity poly(1,4-butylene terephthalate) resins, which include a small amount of e.g., up to 5 mole percent based on the terephthalate units, of a branching component containing at least three ester forming groups. The branching component can be one which provides branching in the acid unit portion of the polyester, or in the glycol unit portion, or it can be hybrid. Illustrative of such branching components are tri- or tetracarboxylic acids, such as trimesic acid, pyromellitic acid, and lower alkyl esters thereof, and the like, or preferably, polyols, and especially preferably, tetrols, such as pentaerythritol, triols, such as trimethylolpropane; or dihydroxy carboxylic acids and hydroxydicarboxylic acids and derivatives, such as dimethyl hydroxyterephthalate, and the like. The branched poly(1,4-butylene terephthalate) resins and their preparation are described in Borman, U.S. Pat. No. 3,953,404, incorporated herein by reference.

In addition to terephthalic acid units, small amounts, e.g., from 0.5 to 15 percent by weight of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like. In addition, the poly(1,4-butylene terephthalate) resin component can also include other high molecular weight resins, in minor amount, such as poly(ethylene terephthalate), block copolyesters of poly( 1,4-butylene terephthalate) and aliphatic/aromatic polyesters, and the like. The molecular weight of the poly(1,4-butylene terephthalate) should be sufficiently high to provide an intrinsic viscosity of about 0.6 to 2.0 deciliters per gram(dl/g), preferably 0.8 to 1.6 dl/g, measured, for example, as a solution in a 60:40 mixture of phenol and tetrachloroethane at 30° C.

Preferred aromatic carbonates are homopolymers, for example, a homopolymer derived from 2,2-bis(4-hydroxyphenyl)propane (bisphenol-A) and phosgene, commercially available under the trade designation LEXAN™ from General Electric Company. When polycarbonate is used, the polyester resin blend component of the composition comprises about 5 to about 50 percent by weight of polycarbonate, and 95 to 50 percent by weight of polyester resin, based on the total weight of the polyester blend component.

The polyester resin blend component may further optionally comprise impact modifiers such as a rubbery impact modifier. Typical impact modifiers are derived from one or more monomers selected from the group consisting of olefins, vinyl aromatic monomers, acrylic and alkyl acrylic acids and their ester derivatives, as well as conjugated dienes. Especially preferred impact modifiers are the rubbery, high-molecular weight materials including natural and synthetic polymeric materials showing elasticity at room temperature. They include both homopolymers and copolymers, including random, block, radial block, graft and core-shell copolymers, as well as combinations thereof. Suitable modifiers include core-shell polymers built up from a rubber-like core on which one or more shells have been grafted. The core typically consists substantially of an acrylate rubber or a butadiene rubber. One or more shells typically are grafted on the core. The shell preferably comprises a vinyl aromatic compound and/or a vinyl cyanide and/or an alkyl(meth)acrylate. The core and/or the shell(s) often comprise multi-functional compounds which may act as a cross-linking agent and/or as a grafting agent. These polymers are usually prepared in several stages.

The blend compositions of the invention may be prepared by such conventional operations as solvent blending and melt blending as by extrusion. They may additionally contain art-recognized additives including pigments, dyes, impact modifiers, stabilizers, flow aids and mold release agents.

The polyamide and cycloaliphatic polyester polymer blend, and blends thereof, may be used in various applications, especially those involving outdoor use and storage and hence requiring resistance to weathering. These include automotive body panels and trim; outdoor vehicles and devices such as lawn mowers, garden tractors and outdoor tools; lighting appliances; and enclosures for electrical and telecommunications systems.

In another embodiment the composition will have a percent transmittance of greater than or equal to about 70% and a glass transition temperature (Tg) of greater than or equal to about 150° C. The immiscible polyetheramide cycloaliphatic polyester resin blends may show enhanced chemical resistance compared to the base polyamide resins.

According to an embodiment, additional ingredients in the resin formulation may enhance processing, and thermal, and color stability of the resin formulation transparent.

According to an embodiment, such additional ingredients may include reactive compatibilizers. Typical reactive compatibilizers include polymeric ionomers, epoxy type, and oxyazoline type compatibilizers.

Examples of suitable polymeric ionomers (hereinafter ionomers) are polymers having moieties selected from the group consisting of sulfonate, phosphonate, and mixtures comprising at least one of the foregoing. Ionomers may be a reaction product of a metal base and the sulfonated and/or phosphonated polymer.

Suitable ionomers have at least about 1, preferably at least about 25, most preferably at least about 50 mol % of the sulfonate and/or phosphonate moieties of the ionomer present in an ionic form. Also at most about 99, preferably at most about 75, most preferably at most about 60 mol % of the sulfonate and/or phosphonate moieties of the ionomer are present In an ionic form.

In one embodiment, the polyesters ionomer copolymers are those derived from poly(ethylene terephthalate) (PET), and poly( 1,4-butylene terephthalate) (PBT), and to poly(1,3-propylene terephthalate), (PPT).

In one embodiment (referred to as PCCDi), the polyester ionomer copolymer has the structure depicted in formula 11 below: 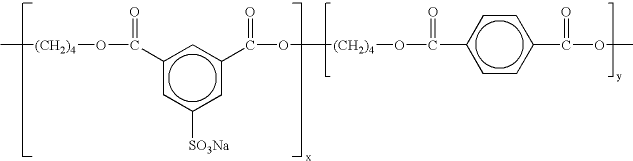
where the ionomer units, x, are from 0.1-20 mole % when y is 1 and the end-groups consist essentially of carboxylic acid (—COOH) end-groups and hydroxyl (—OH) end-groups. Polyester ionomers (see “ionomer+polyester.rtf”; truncated listing) are desirable as compatibilizers in blends.

According to an embodiment, polyester ionomers have the following formula 12 structure: 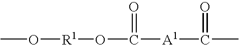
wherein each R1 is typically a divalent aliphatic, alicyclic or aromatic hydrocarbon or polyoxyalkylene radical, or mixtures thereof and each A1 is independently a divalent aliphatic, alicyclic or aromatic radical, or mixtures thereof. According to an embodiment, a portion of the polyester ionomer include R1 as cycloaliphatic units of CHDM-based polyesters.

According to an embodiment, 1-30 mol % of the A1 units are comprised of sulfonated aromatic radicals of formula 13: 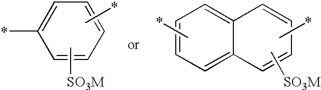
where M can be any mono- or di- or tri-valant cation including but not limited to Li, Na, K, Mg, Ca, Zn, Cu, Fe, NH4, tetraalkylammoniums (Me4N, Et4N, Pr4N, Bu4N) or tetraalkylphosphonium (Bu4P). The range of sulfoacids as described in U.S. Pat. No. 3,779,993 are included as a reference and should be included in the scope of this invention as well.

The remainder of the A1 units can be derived from other diacids including succinic, glutaric, adipic, azelaic, sebacic, fumaric, maleic, itaconic, benzene dicarboxylic (including phthalic, isophthalic, terephthalic), naphthalene dicarboxylic, and cyclohexane dicarboxylic acids. Mixtures of these diacid units may also be used. Both the sulfonated and non-sulfonated A1 units may be derived from either diacids or diester compounds. The most typical diester used in the manufacture of these polyesters is a dimethyl ester, such as dimethyl terephthalate, but any aliphatic, alicyclic or aromatic diester could be used.

R1 consists of 10-100 mol % of CHDM. The remainder of the R1 units may be derived from individual or mixtures of any C2-C12 aliphatic, cycloaliphatic, aromatic hydrocarbon, or polyoxyalkylene glycols including, but not limited to ethylene glycol, 1,3-propane glycol, 1,2-propanediol, 2,4-dimethyl-2 ethylhexane-1,3-diol, 2,2-dimethyl-1, 3-propanediol, 2-ethyl-2-butyl-1,3-propanediol, 2-ethyl-2-isobutyl-1,3-propanediol, 1,3-butanediol, 1,4-butanediol, neopentylglycol, 1,5-pentanediol, 1,6-hexanediol, 1,8-octanediol, 2,2,4-trimethyl-1,6-hexanediol, 1,2-cyclohexanedimethanol, 1,3-cyclohexanedimethanol, 1,4-benzenedimethanol, diethyleneglycol, thiodiethanol, 2,2,4,4-tetramethyl-1, 3-cyclobutanediol, etc.

According to an embodiment, such additional ingredients may include multifunctional epoxies. In one embodiment the stabilized composition of the present invention may optionally comprise at least one epoxy-functional polymer. One epoxy polymer is an epoxy functional (alkyl)acrylic monomer and at least one non-functional styrenic and/or (alkyl)acrylic monomer. In one embodiment, the epoxy polymer has at least one epoxy-functional (meth)acrylic monomer and at least one non-functional styrenic and/or (meth)acrylic monomer which are characterized by relatively low molecular weights. In another embodiment the epoxy functional polymer may be epoxy-functional styrene (meth)acrylic copolymers produced from monomers of at least one epoxy functional (meth)acrylic monomer and at least one non-functional styrenic and/or (meth)acrylic monomer. As used herein, the term (meth) acrylic includes both acrylic and methacrylic monomers. Non limiting examples of epoxy-functional (meth)acrylic monomers include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl emer, glycidyl ethacrylate, and glycidyl itoconate.

According to an embodiment, such additional ingredients may include reactive oxazoline compositions. Resins, useful in the present invention, may be reacted with iminoether functional groups, preferably cyclic iminoethers. Such compounds are described in Hohlfeld, U.S. Pat. No. 4, 590,241, and are commonly called reactive alkenyl aromatics. Preferred is an oxazoline compound such as a 2-alkyl or 2-alkenyl-2-oxazoline. Especially preferred is about 0.01 to about 10 percent by weight of a 2-alkenyl-2-oxazoline compound such as 2-isopropenyl-2-oxazoline.

Additional additives such suitable dyes, pigments, and special effects additives as is known in the art, as well as mold release agents, antioxidants, lubricants, nucleating agents such as talc and the like, other stabilizers including but not limited to UV stabilizers, such as benzotriazole, supplemental reinforcing fillers, and the like, flame retardants, pigments or combinations thereof.

The polyester resin blend component may further optionally comprise impact modifiers such as a rubbery impact modifier. Typical impact modifiers are derived from one or more monomers selected from the group consisting of olefins, vinyl aromatic monomers, acrylic and alkyl acrylic acids and their ester derivatives, as well as conjugated dienes. Especially preferred impact modifiers are the rubbery, high-molecular weight materials including natural and synthetic polymeric materials showing elasticity at room temperature. They include both homopolymers and copolymers, including random, cycloaliphatic, radial cycloaliphatic, graft and core-shell copolymers, as well as combinations thereof. Suitable modifiers include core-shell polymers built up from a rubber-like core on which one or more shells have been grafted. The core typically consists substantially of an acrylate rubber or a butadiene rubber. One or more shells typically are grafted on the core. The shell preferably comprises a vinyl aromatic compound and/or a vinyl cyanide and/or an alkyl(meth)acrylate. The core and/or the shell(s) often comprise multi-functional compounds which may act as a cross-linking agent and/or as a grafting agent. These polymers are usually prepared in several stages.

The resin may include various additives incorporated in the resin. Such additives include, for example, fillers, reinforcing agents, heat stabilizers, antioxidants, plasticizers, antistatic agents, mold releasing agents, additional resins, blowing agents, and the like, such additional additives being readily determined by those of skill in the art without undue experimentation. Examples of fillers or reinforcing agents include glass fibers, asbestos, carbon fibers, silica, talc, and calcium carbonate. Examples of heat stabilizers include triphenyl phosphite, tris-(2,6-dimethylphenyl)phosphite, tris-(mixed mono-and di-nonylphenyl)phosphite, and dimethylbenene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of plasticizers include dioctyl-4,5-epoxy-hexahydrophthalate, tris-(octoxycarbonylethyl)isocyanurate, tristearin, and epoxidized soybean oil. Examples of antistatic agents include glycerol monostearate, sodium stearyl sulfonate, and sodium dodecylbenzenesulfonate. Examples of mold releasing agents include stearyl stearate, beeswax, montan wax, and paraffin wax. Examples of other resins include but are not limited to polypropylene, polystyrene, polymethyl methacrylate, and polyphenylene oxide. Individual, as well as combinations of the foregoing may be used. Such additives may be mixed at a suitable time during the mixing of the components for forming the composition.

The weatherable compositions are suitable for a wide variety of uses, for example in automotive applications such as body panels, cladding, and mirror housings; in recreational vehicles including such as golf carts, boats, and jet skies; and in applications for building and construction, including, for example, outdoor signs, ornaments, and exterior siding for buildings. The final articles can be formed by compression molding, multiplayer blow molding, coextrusion of sheet or film, injection over molding, insertion blow molding and other methods.

From an aesthetic standpoint, the use of color pigments for special visual effects may be utilized. Such ingredients may include a metallic-effect pigment, a metal oxide-coated metal pigment, a platelike graphite pigment, a platelike molybdenumdisulfide pigment, a pearlescent mica pigment, a metal oxide-coated mica pigment, an organic effect pigment a layered light interference pigment, a polymeric holographic pigment or a liquid crystal interference pigment. Preferably, the effect pigment is a metal effect pigment selected from the group consisting of aluminum, gold, brass and copper metal effect pigments; especially aluminum metal effect pigments. Alternatively, preferred effect pigments are pearlescent mica pigments or a large particle size, preferably platelet type, organic effect pigment selected from the group consisting of copper phthalocyanine blue, copper phthalocyanine green, carbazole dioxazine, diketopyrrolopyrrole, iminoisoindoline, irninoisoindolinone, azo and quinacridone effect pigments.

Suitable colored pigments may be included in the resin blend. Such pigments include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, or a mixture or solid solution thereof.

Suitable colored pigments also include inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate and mixed metal oxides.

Most preferably, the colored pigment is a transparent organic pigment. Pigment compositions wherein the colored pigment is a transparent organic pigment having a particle size range of below 0.2 μm, preferably below 0.1 μm, are particularly interesting. For example, inventive pigment compositions containing, as transparent organic pigment, the transparent quinacridones in their magenta and red colors, the transparent yellow pigments, like the isoindolinones or the yellow quinacridone/quinacridonequinone solid solutions, transparent copper phthalocyanine blue and halogenated copper phthalocyanine green, or the highly-saturated transparent diketopyrrolopyrrole or dioxazine pigments are particularly interesting.

Typically the pigment composition is prepared by blending the pigment with the filler by known dry or wet mixing techniques. For example, the components are wet mixed in the end step of a pigment preparatory process, or by blending the filler into an aqueous pigment slurry, the slurry mixture is then filtered, dried and micropulverized.

In a preferred method, the pigment is dry blended with the filler in any suitable device which yields a nearly homogenous mixture of the pigment and the filler. Such devices are, for example, containers like flasks or drums which are submitted to rolling or shaking, or specific blending equipment like for example the TURBULA mixer from W. Bachofen, CH-4002 Basel, or the P-K TWIN-SHELL INTENSIFIER BLENDER from Patterson-Kelley Division, East Stroudsburg, Pa. 18301. The pigment compositions are generally used in the form of a powder which is incorporated into a high-molecular-weight organic composition, such as a coating composition, to be pigmented. The pigment composition consists of or consists essentially of the filler and colored pigment, as well as customary additives for pigment compositions. Such customary additives include texture-improving agents and/or antiflocculating agents.

The polymer blend desirable has a percent transmittance, as measured by ASTM D1003, of greater than or equal to about 50, or even greater than or equal to about 75%. According to an embodiment, the polymer blend polymer comprises from 1 to about 99 percent by weight polyamide resin and from about 1 to about 99 percent by weight cycloaliphatic copolyestercarbonates resin, and according to another embodiment comprises from 10 to about 90 percent by weight polyamide resin and from about 10 to about 90 percent by weight cycloaliphatic polyester resin.

A polymer blend embodiment having barrier properties comprises from 75 to about 90 percent by weight polyamide resin and from about 25 to about 10 percent by weight cycloaliphatic polyester resin. A polymer blend having chemical resistance comprises a polymer comprising from 10 to about 25 percent by weight polyamide resin and from about 75 to about 90 percent by weight cycloaliphatic polyester resin. Another blend comprises from 75 to about 90 percent by weight polyamide resin and from about 10 to about 25 percent by weight cycloaliphatic polyester resin.

The composition may include a compatibilizer which is reactive with the polyamide and polyester portions of the blend. Typical reactive compatibilizers include ionomeric, epoxy, or oxazoline compatibilizer which are present in a compatibilizing amount, typically from about 0.1 to about 5 percent by weight based on the total weight of the blend.

Other additives may be present in amounts which do not affect the favorable properties of the polymer blend, typically in amounts from about 1 to about 20 percent by weight based on the total weight of the polymer blend. These additional ingredients typically comprising suitable dyes, pigments, special color effects additives, mold release agents, antioxidants, lubricants, nucleating agents, stabilizers, reinforcing fillers, flame retardants, impact modifiers, flow aids or mold release agents.

According to an embodiment the article may be the form of a film or sheet or molded article. Transparent articles included substantially transparent articles in which the polyamide and the polyester resin have substantially matching indexes of refraction.

In forming a transparent article, a polycarbonate resin that is miscible with the cycloaliphatic polyester resin may be included for adjusting the index of refraction of the miscible blend to obtain a resulting refractive index substantially matching said polyamide. The polycarbonate resin is desirable present in an amount for adjusting the index of refraction of the miscible blend for enhancing transparency. The transparency of an article may be intentionally reduced by the inclusion of additional ingredients. It is desirable that the polyamide and to immiscible resin portion have substantially matching indexes of refraction.

The ingredients of the examples shown below in Tables, were tumble blended and then extruded on a 30 mm Werner Pfleiderer Twin Screw Extruder with a vacuum vented mixing screw, at a barrel and die head temperature between 260-280° C. and 300 rpm screw speed. The extrudate was cooled through a water bath prior to pelletizing. Test parts were injection molded on a van Dorn molding machine with a set temperature of approximately 260-280° C. The pellets were dried under vacuum overnight prior to injection molding.

Tensile elongation at break was tested on 7×⅛ in. injection molded bars at room temperature with a crosshead speed of 2 in./min. using ASTM method D648. Notched Izod testing was done on 3×½×⅛ inch bars using ASTM method D256.

Chemical resistance tests were performed on ISO tensile bars using the Berg-n-jig method at 0, 0.5 or 1% strain for periods of 24, 48 or 64 hours. At times, chemical resistance was monitored by assessing the visual appearance.

The optical measurements such as % transmission, haze and yellowing index (Y1) were run on Gretag Macbeth CE 7000, running Optiview Propallette software. Y1 was measured according to ASTM E313-73, Correlated Haze was measured using CIE Lab, Illum C @ 10°, % T was run using test method CIE_{—}1931 (XYZ) and measured in CIE Lab, Illum C at 2°.

Biaxial impact testing, sometimes referred to as instrumented impact testing, was done as per ASTM D3763 using a 4×⅛ inch molded discs. The total energy absorbed by the sample is reported as ft-lbs. Testing was done at room temperature on as molded or as weathered samples.

Accelerated weathering test was done as per ASTM-G26. The samples of 2×3×⅛ inch molded rectangular specimen, “color chip”, were subjected to light in xenon arc weatherometer equipped with borosilicate inner and outer filters at an irradiance of 0.35 W/m2 at 340 nm, using cycles of 90 min light and 30 min dark with water spray. The humidity and temperature were kept at 60% and 70o C., respectively.

Chip color was measured on a ACS CS-5 ChromoSensor in reflectance mode with a D65 illuminant source, a 10 degree observer, specular component included, CIE color scale as described in “Principles of Color Technology” F. W. Billmeyer and M. Saltzman/John Wiley & Sons, 1966. The instrument was calibrated immediately prior to sample analysis against a standard white tile. The color values reported below are the difference before and after UV exposure. The color change is expressed as delta E. Testing was done as per ASTM D2244.

Following are examples. Examples of different components that have been used are shown below in Table 1
1. Trogamid CX7323 (Degussa-Huls)—Cycloaliphatic diamine+DDDA (Dodecanedioic acid)
2. PCCD purchased from Eastman.
3. PCCDi has been synthesized in-house.

The table below shows the R1 for each of these materials.

TABLE 1
Refractive Indices (RI) of various nylons

| Nylon | RI |
|---|---|
| CX7323 | 1.516 |
| PCCD | 1.506 |
| PCCDi (2-10%) | 1.500-1.510 |

Note that PCCD by itself is a microcrystalline material and has good chemical resistance. Hence the blends are desirable from both chemical resistance as well as weatherability considerations.

Table 1 shows a range of compositions over which transparent/translucent blends of PC-PCCD-Trogamid can be synthesized. Transmission properties of the blend are compared to that of pure Trogamid.

| | A | 1 | 2 | 3 | 4 | 5 | 6 |
|---|---|---|---|---|---|---|---|
| PCCD | 0 | 48 | 37 | 36 | 36 | 34 | 40 |
| PC | 0 | 2 | 3 | 4 | 5 | 6 | 10 |
| CX7323 | 100 | 50 | 60 | 60 | 60 | 60 | 50 |
| Transmission @ 32 mm | 90 | 83 | 86 | 85 | 89 | 87 | 85 |
| RI of PC-PCCD phase | — | 1.509 | 1.512 | 1.514 | 1.516 | 1.518 | 1.522 |

The examples A as well as 1-6 also contain 0.25% CESA (ADR 4368) which is a multifunctional epoxide copolymer of styrene and glycidylmethacrylate from Johnson Polymers Co.

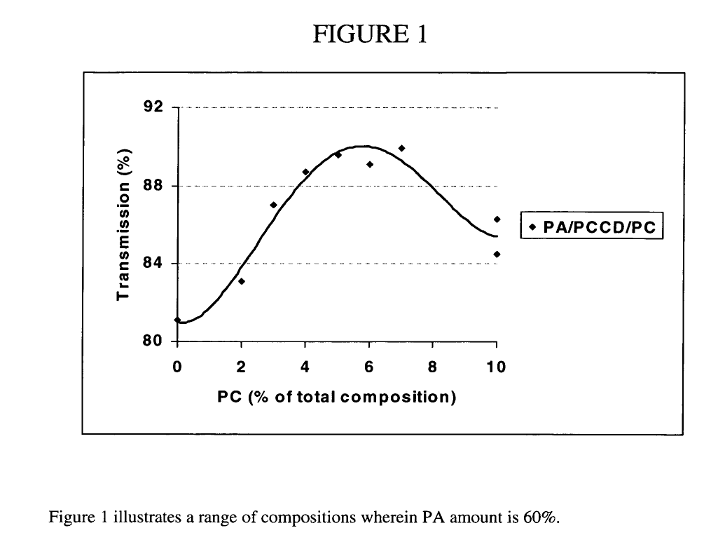

FIG. 1 highlights the validity of the approach. Shown is the change in % transmission of the polyamide-PC/PCCD blend as a function of % composition of PC in the blend (or in other words the % T vs. the R1 differential between the PC/PCCD and the polyamide). The fact that we see close to 90% transmission in the system indicates the merit. Further, it is important to note that the approach facilitates the formulation of transparent blends over the entire compositional range (95% polyamide-5% blend and vice versa).

Table 2 shows difunctional epoxy compatibilization for synthesizing blends. Transmission is relatively unaffected while notched Izod is maintained or improved upon that of Trogamid. Loeer levels of functionality seem to favor compatibilization compared to higher levels of functionality.

| | B | 7 | 8 |
|---|---|---|---|
| PCCD | — | 48 | 48 |
| PC | — | 2 | 2 |
| CX7323 | 100 | 50 | 50 |
| Epoxidized soybean oil | — | — | — |
| Cyloaliphatic epoxy resin (ERL 5221) | — | 0.2 | — |
| Transmission @ 3.2 | 90 | 84 | 84 |
| Notched Izod (k.l/m2) | 10 | 20 | 18 |

Table 3 shows the multifunctional epoxy compatibilization technology in these blends. Improved toughness via maintaining or improving elongation at break is observed.

| | C | 9 | 10 | 11 |
|---|---|---|---|---|
| PCCD-content | — | 36 | 35 | 34 |
| PC-content | — | 4 | 5 | 6 |
| CX7323 content | 100 | 60 | 60 | 60 |
| CESA - multifunctional | — | 0.25 | 0.25 | 0.25 |
| epoxy | | | | |
| Transmission @ 3.2 mm | 90 | 85 | 89 | 87 |
| Elongation at break (%) | 159 | 146 | 164 | 173 |

Use of appropriate amount of polycarbonate enables achievement simultaneously of a good combination of high transmission and elongation at break (%).

Table 4 shows optical and physical properties that characterize blends of PC-PCCD-Trogamid relative to Trogamid and PC-PCCD blend.

| | D | E | 12 | 13 |
|---|---|---|---|---|
| PCCD | — | 85 | 65 | 35 |
| PC | — | 15 | 10 | 4 |
| CX7323 | 100 | — | 25 | 60 |
| CESA | — | — | 0.25 | 0.25 |
| Transmission @ 32 | 90 | 88 | 89 | 89 |
| Tensile Modulus | 210000 | 184000 | 184000 | 210000 |
| Elongation at break | 159 | 198 | 198 | 164 |
| (%) | | | | |
| Oleic acid | Small cracks | No visual | No visual | No visual |
| | | effect | effect | effect |
| acetone | No visual | Haze | No visual | No visual |
| | effect | | effect | effect |

Table 5 shows use of compatibilization technology for Trogamid/PCCDi(5%) blends.

Presence of the multifunctional epoxy as expected reduces flow, but surprisingly improves optical properties

Presence of the multifunctional epoxy improves overall toughness and heat properties

| | | | |
|---|---|---|---|
| H | I | 20 | 21 |

| | | | | |
|---|---|---|---|---|
| CX7323 | 80 | 90 | 80 | 90 |
| PCCDi5 | 20 | 10 | 20 | 10 |
| CESA | — | — | 0.25 | 0.25 |
| YI | 29 | 12 | 14 | 10 |
| Transmission | 70 | 84 | 80 | 86 |
| Flow (265 C, 2.16 kg, | 8.65 | 7.72 | 3.9 | 4.77 |
| 240 sec) | | | | |
| Tensile strgth @ brk | 7050 | 8120 | 8760 | 8870 |
| (psi) | | | | |
| Elongation @ brk (%) | 131 | 157 | 187 | 173 |
| HDT (° C.) @ 264 psi | 76.1 | 84.9 | 79.6 | 86.1 |

Table 6 shows optical properties as a function of ionomeric content in PCCD copolymer

Optical properties and ductility improving with increasing level of ionomeric content

Flow and HDT properties improve with decreasing level of ionomeric content

| | G | 17 | 18 | 19 |
|---|---|---|---|---|
| CX7323 | 100 | 80 | 80 | 80 |
| Ionomer level | — | 20 | 20 | 20 |
| PCCDi content | — | 2 | 5 | 10 |
| Transmission | 90 | 76 | 80 | 83 |
| Flow (265 C, 2.16 kg, | 3 | 4.27 | 3.9 | 3.46 |
| 240 sec) | | | | |
| Elongation @ brk (%) | 159 | 144 | 187 | 164 |
| Notched Izod (kJ/m2) | 9.515 | 7.07 | 17.52 | 13.59 |
| Dynatup energy (ft-lbf) | 43.9 | 49.6 | 48.1 | 55.1 |
| HDT (deg.C) @ 264 psi | 93.8 | 85.6 | 79.6 | 75.1 |

Table 7 shows effect of increasing the copolymer level in the blend

Flow improves with increasing level of copolymer level while heat decreases.

Material toughness and optical properties seem to plateau out from 20-40% of copolymer in the blend.

| | J | 22 | 23 | 24 | 25 |
|---|---|---|---|---|---|
| CX7323 | 100 | 90 | 80 | 70 | 60 |
| PCCDi5 | — | 10 | 20 | 30 | 40 |
| CESA | — | 0.25 | 0.25 | 0.25 | 0.25 |
| Transmission | 90 | 86 | 80 | 80 | 80 |
| Flow (265 C., 2.16 kg, | 3 | 3.77 | 3.9 | 4.71 | 5.35 |
| 240 sec) | | | | | |
| Dynatup energy (ft-lbf) | 43.9 | 44.1 | 48.1 | 51.2 | 45.4 |
| Elongation @ brk (%) | 158.74 | 172.8 | 187.43 | 191.8 | 187.82 |
| HDT (° C.) @ 264 psi | 93.8 | 86.1 | 79.6 | 77.3 | 63.3 |

The ionomer content in the PCCD is 5% in Table 7.

Table 8 shows how the blend maintains optical properties and shows an improvement in chemical resistance with the presence of PCCDi.

| | F | 14 | 15 | 16 |
|---|---|---|---|---|
| CX7323 | 100 | 80 | 80 | 90 |
| PCCD | — | 20 | 20 | 10 |
| PCCDi | — | 2 | 5 | 5 |
| Transmission | 90 | 76 | 80 | 86 |
| Chemical | Stained | No visual | No visual effect | No visual effect |
| resistance | after 48 | effect after | after 48 hours | after 48 hours |
| | hours | 48 hours | | |

Tables show parts by weight of the various ingredients. For the chemical resistant testing, a perfume from Carolina Herrera was used.

These blend systems are transparent, chemically resistant and in some examples show low temperature ductility.

1. A transparent composition comprising an amorphous polyamide, a cycloaliphatic polyester resin, and a compatibilizing additive.

2. The transparent composition of claim 1 comprising from about 5 to about 95 percent by weight polyamide resin, from about 5 to about 50 percent by weight of a cycloaliphatic polyester resin, and from about 0.01 to about 2 percent by weight of a compatibilizing additive.

3. The transparent composition of claim 1 comprising a cycloaliphatic copolyester resin.

4. The transparent composition of claim 3 wherein said cycloaliphatic copolyester is a polyester ionomer.

5. The transparent composition of claim 1 comprising a resin immiscible with said amorphous polyamide and miscible with said cycloaliphatic polyester for enhancing the transparency of said composition.

6. The transparent composition of claim 5 wherein said immiscible resin comprises a polycarbonate.

7. The transparent composition of claim 6 comprising from about 5 to about 95 percent by weight polyamide resin, from about 5 to about 50 percent by weight of a cycloaliphatic polyester resin, and from about 0.01 to about 2 percent by weight of a compatibilizing additive, and wherein said polycarbonate resin is present in amount for enhancing the transparency of said composition.

8. The transparent composition of claim 5 wherein the immiscible resin comprises from about 10 to about 90 percent by weight cycloaliphatic resin and from about one to about 20 percent by weight of an index of refraction adjusting amount of a resin miscible with said cycloaliphatic polyester resin.

9. The transparent composition of claim 5 wherein the polymer blend has a percent transmittance, as measured by ASTM D1003, of greater than or equal to about 50%.

10. The transparent composition of claim 5 wherein the polymer blend has a percent transmittance, as measured by ASTM D1003, of greater than or equal to about 75%.

11. The transparent composition of claim 5 wherein said cycloaliphatic polyester said cycloaliphatic polyester resin comprising the reaction product of an aliphatic C₂-C₁₂ diol or chemical equivalent and a C₆-C₁₂ aliphatic diacid or chemical equivalent, said cycloaliphatic polyester resin containing at least about 80% by weight of a cycloaliphatic dicarboxylic acid, or chemical equivalent, and/or of a cycloaliphatic diol or chemical equivalent.

12. The transparent composition of claim 11 wherein said cycloaliphatic polyester resin comprises the reaction product of a C₆-C₁₂ cycloaliphatic diol or chemical equivalent and a C₆-C₁₂ cycloaliphatic diacid or chemical equivalent.

13. The transparent composition of claim 12 wherein said cycloaliphatic polyester resin comprises cycloaliphatic polyester is comprised of cycloaliphatic diacid and cyclo cycloaliphatic polyester resin aliphatic diol units

14. The transparent composition of claim 13 wherein said cycloaliphatic polyester resin comprises the reaction product of polycyclohexane dimethanol and cyclohexane dicarboxylate.

15. The transparent composition of claim 5 comprising a reactive compatibilizer.

16. The transparent composition of claim 15 comprising a reactive ionomeric, epoxy, or oxaoline compatibilizer.

17. The transparent composition of claim 15 comprising a reactive ionomeric polymeric sulfonate compatibilizer.

18. The transparent composition of claim 15 comprising a reactive polymeric epoxy compatibilizer.

19. The transparent composition of claim 15 comprising a reactive oxaoline compatibilizer comprising a pendant cyclic iminoether cyclic.

20. A composition comprising a polymer blend of a polyamide resin having a predetermined index of refraction and an immiscible resin, said immiscible resin comprising cycloaliphatic polyester resin and a resin miscible with said cycloaliphatic polyester resin for adjusting the index of refraction of said immiscible resin to substantially match the index of refraction of said polyamide resin.

21. The composition of claim 20 wherein said immiscible resin comprises a polyester ionomer.

22. The composition of claim 21 wherein said polyester ionomer comprises a cycloaliphatic copolyester ionomer.

23. The composition of claim 20 wherein the miscible resin comprises a polycarbonate resin.

24. The composition of claim 23 wherein the polymer blend has a percent transmittance, as measured by ASTM D1003, of greater than or equal to about 75%.

25. The composition of claim 24 wherein said cycloaliphatic polyester said cycloaliphatic polyester resin comprising the reaction product of an aliphatic C₂-C,₁₂ diol or chemical equivalent and a C₆-C₁₂ aliphatic diacid or chemical equivalent, said cycloaliphatic polyester resin containing at least about 80% by weight of a cycloaliphatic dicarboxylic acid, or chemical equivalent, and/or of a cycloaliphatic diol or chemical equivalent.

26. The composition of claim 25 wherein said cycloaliphatic polyester resin comprises the reaction product of a C₆-C₁₂ cycloaliphatic diol or chemical equivalent and a C₆-C₁₂ cycloaliphatic diacid or chemical equivalent.

27. The composition of claim 26 wherein said cycloaliphatic polyester resin comprises cycloaliphatic polyester is comprised of cycloaliphatic diacid and cyclo cycloaliphatic polyester resin aliphatic diol units

28. The composition of claim 27 wherein said cycloaliphatic polyester resin comprises the reaction product of polycyclohexane dimethanol and cyclohexane dicarboxylate.

29. The composition of claim 18 comprising a reactive oxaoline compatibilizer comprising a pendant cyclic iminoether cyclic.

30. A formed article comprising a polymer blend of a polyamide resin having a predetermined index of refraction and an immiscible resin, said immiscible resin comprising cycloaliphatic polyester resin and a resin miscible with said cycloaliphatic for adjusting the index of refraction of said immiscible resin to substantially match the index of refraction of said polyamide resin

31. The formed article of according to claim 24 wherein said polymer blend of a polyamide resin and cycloaliphatic polyester comprises from 10 to about 90 percent by weight polyamide resin and from about 10 to about 90 percent by weight cycloaliphatic polyester resin.

32. The formed article according to claim 25 comprising a film or sheet.

33. The formed article according to claim 26 wherein said article is substantially transparent.

34. A process for forming an article comprising selecting a polyamide resin having a predetermined index of refraction, blending said polyamide resin with an immiscible resin, said immiscible resin comprising cycloaliphatic polyester resin and a resin miscible with said cycloaliphatic for adjusting the index of refraction of said immiscible resin to substantially match the index of refraction of said polyamide resin and form a resulting resin blend, and forming said substantially transparent article from said resulting blend.
